(19) United States
(12) Patent Application Publication
(10) Pub. No.: US 2005/0111044 A1
(43) Pub. Date: May 26, 2005

(54) Incremental rendering

(75) Inventor: Fabio Giannetti, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 10/993,425

(22) Filed: Nov. 22, 2004

(30) Foreign Application Priority Data
Nov. 26, 2003 (GB) 0327419.8

(51) Int. Cl. G06F 15/00

(52) U.S. Cl. 358/1.18; 358/1.16

(57) ABSTRACT

A method of generating a copy flow comprises identifying a set of re-useable objects; rendering said identified re-useable objects; storing said identified rendered re-useable objects; and storing an identification data, identifying a position within at least one document of said re-useable objects.

### FIELD OF THE INVENTION

The present invention relates to rendering of digital copy.

### BACKGROUND OF THE INVENTION

Known publishing solutions operate either by using a known off set printing press, or by using a digital printing press. With a conventional off set printing press, a master document needs to be copied, and then a run of copies, for example 5,000 or 10,000 copies are printed off. Known digital printing presses have an advantage that successive individual print items which are different to each other can be printed without interrupting the work flow, that is, without interrupting the logical sequence of steps required to perform a printing operation. With the known digital printing press, a digital master document is electronic, and a number of print items in a print run is variable. Small print runs from one print item upwards can be accommodated. Known digital printing presses are capable of printing a print run comprising a plurality of print items, wherein individual print items within the print run can be different to each other.

Referring to FIG. 1 herein, there is illustrated schematically in perspective view, a known digital printing press.

Conventionally, it is known to prepare documents for printing in a digital printing press, using the known personal printing mark up language (PPML). In the known PPML, a graphic artist may define a number of “copy holes” in a PPML document. The PPML document comprises one or a plurality of pages. Each page has one or more copy holes which can be positioned by a user on the page. Each copy hole is defined by a width a, height, and a 2-dimensional position on a page.

Inside each copy hole there is placed content, for example text content comprising a plurality of lines of text. Consequently, in known PPML work flows, everything is static. All aspects of layout and content are predetermined and are positioned on the page, induding the copy holes, and the content within the copy holes. A graphic artist designs the PPML page, and then inserts static text and/or objects within the copy holes using a conventional graphic artist package, for example the known ‘Express’ tool from QUARK.

In contrast, XSL-FO belongs to a class of languages known as document description languages, DDL, which are languages which describe whole documents, rather than individual pages. In XSL-FO, there is no concept of one page, but there is a concept of a sequence of pages making up a document, and there is also a concept of where the content will be positioned within a page sequence.

Often, a print run comprises a plurality of documents which are of a customised nature, being specific to individual addressees, but which may have an element of common material which appears in successive documents in a print run. When receiving a copy flow comprising a plurality of documents, in which part of the content is common between successive documents, known digital printing presses need to render the content separately for each document in the copy flow. Rendering is a computationally expensive operation and is a limiting factor on increasing the through put of a digital printing press.

One known prior art publishing software which allows variable picture information to be included in a copy flow is the Design Merge suite of software modules for the known Quark Express product. This allows documents to be personalized and for variable content to be included in a base document template.

However, known prior art solutions work with static layout, and generate images of pages without having a detailed separation of re-useable components from instance specific components. Known prior art solutions tend to generate complete images of pages inside a document, which disables the re-use features available with PPML. Most known solutions embed a PDF page inside a PPML document tag, relying only on the PDF internal optimisation for object reuse. This does not allow the press to perform a single rasterizing processes.

Conventional known printing presses work mainly with static layout documents, and are not enabled for transactional documents.

### SUMMARY OF THE INVENTION

According to one aspect of the present invention, there is provided a method for producing a copy flow from an XSL-FO input, said method comprising:
receiving an XSL-FO document which identifies at least one document sequence, wherein said document sequence identifies at least one static content item, and at least one dynamic content item;
rendering said at least one static content item, and storing said rendered at least one static content item;
rendering said at least one dynamic content item; and
generating a PPML document which comprises a set of re-useable rendered content items and position information for positioning said rendered content items.

Other aspects of the invention are as recited in the claims herein.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 illustrates schematically in perspective view, a known digital printing press;

FIG. 2 illustrates schematically a printing system comprising a graphic artist authoring tool, a marketing manager tool, and a digital printing press, according to a specific embodiment of the present invention;

FIG. 3a illustrates schematically a first document in a print run of documents, having one or more regions of static content, and at least one region of variable content;

FIG. 3b illustrates schematically a second document in a document run, having the same regions of static content, and a different region of variable content;

FIG. 3c illustrates schematically a third document in the document run, having static content areas in common with the first document, and a variable content region which displaces one of the static content regions;

FIG. 3d illustrates schematically a fourth document in the print run, having static content in common with the first document, and having a variable content region which displaces one of the static content items of the first document;

FIG. 4 illustrates schematically a rendering process for rendering an XSL-FO copy flow to a personal printing mark up language (PPML) flow;

FIG. 5 illustrates schematically an example of a command extension to XSL-FO, and interpretation of the command by a rendering engine to store an identification of the static content item;

FIG. 6 illustrates schematically processes for identifying and storing re-useable content, as carried out by a modified rendering engine;

FIG. 7 illustrates schematically internal structure and operation of a modified rendering engine according to the specific embodiment of the present invention;

FIG. 8 illustrates schematically an example of a PPML output of the modified rendering engine;

FIG. 9 illustrates schematically processes carried out by the modified rendering engine for producing a PPML flow having re-useable objects, variable objects, and references to the re-useable objects;

FIG. 10 illustrates schematically further processes for production on the press of a copy flow according to a specific method of the present invention;

FIG. 11 illustrates schematically one example of a transactional document, having a set of static content objects;

FIG. 12 illustrates schematically the transactional document of FIG. 11, illustrating a set of variable content components;

FIG. 13 illustrates schematically first and second page sequences comprising first and second documents in a PPML flow, wherein there are elements of common static content between the two documents, and variable content, which is specific to each document;

FIG. 14 illustrates schematically two instances of a first page of two separate documents in a print run, illustrating how static objects can be shifted by inclusion of a variable object, between two separate documents;

FIG. 15 illustrates schematically a first page of a first document shown in FIG. 14 and a second page of the second document shown in FIG. 14, showing how a static content item is repositioned using a MARK element in PPML, without effecting the re-usability of the static content object; and

FIG. 16 illustrates schematically a rendering process for rendering from extended XSL-FO into PPML to produce a PPML document suitable for processing in a PPML consumer according to a specific embodiment of the present invention.

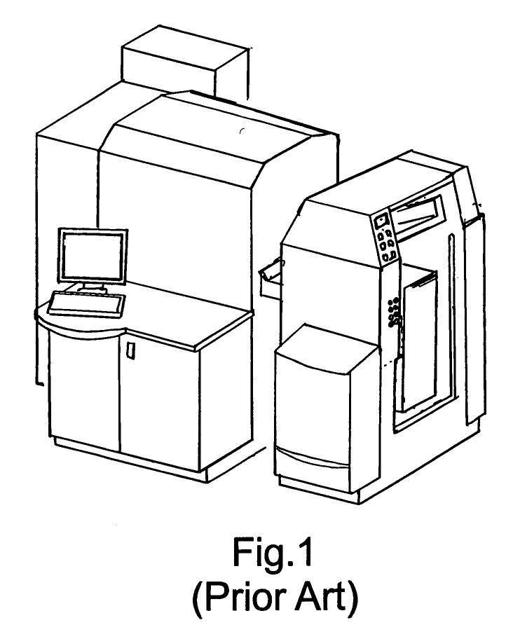

### DETAILED DESCRIPTION

There will now be described by way of example a specific mode contemplated by the inventors. In the following description numerous specific details are set forth in order to provide a thorough understanding. It will be apparent however, to one skilled in the art, that the present invention may be practiced without limitation to these specific details. In other instances, well known methods and structures have not been described in detail so as not to unnecessarily obscure the description.

Supposing a run of print items needs to be printed, where each print item is customised for a different recipient. An example of such a print run may include a run of credit card statements, where each person's spending pattern is different, a run of bank statements, a run of personal cheques, or some other print items where the content is personalised and differs from print item to print item. Typically, there will be a document template, which is an electronic document specifying a general layout of a document to be printed. The content is incorporated in an extensible style sheet language formatting objects (XSL-FO) flow.

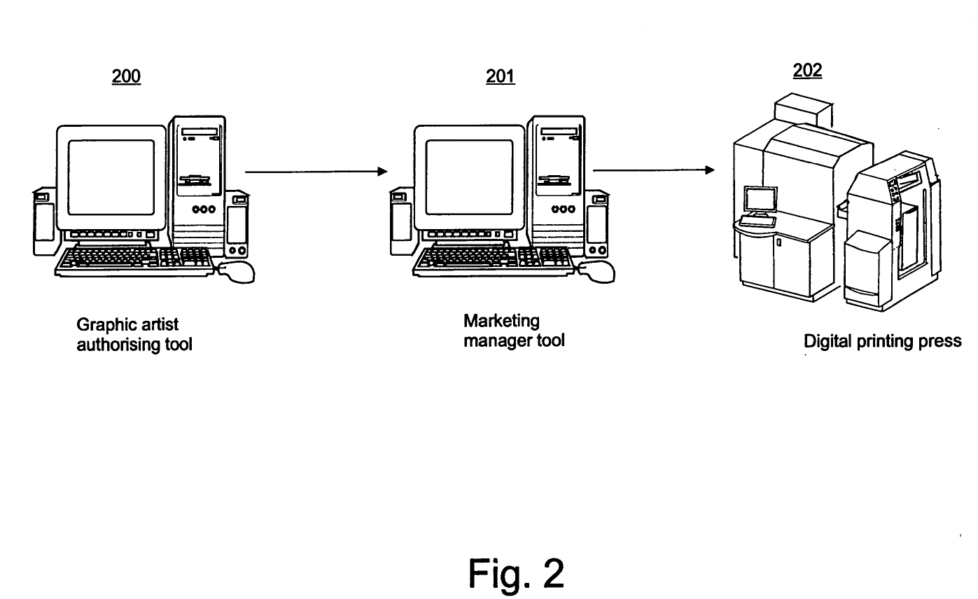

Referring to FIG. 2 herein, there is illustrated schematically elements of a printing system for creating and printing a run of documents, in which successive documents in the print run may be different from each other, and customised to individual recipients, and where there is re-useable content which may be common to a plurality of documents within the print run.

The system comprises a graphic artist authoring tool 200 for generating a page layout of each document, induding a plurality of copy-holes which contain static content which does not change between successive documents in a print run, and one or more variable copy-holes, which contains variable content which differs from document; a marketing manager tool 201 which receives a copy flow from the graphic artist authoring tool, and which may insert variable content, for example name and address data, account details or the like into the variable copy-holes of the print run; and a digital printing press 202, comprising a printed mechanism, a control component, a rendering engine, and an output collater for collating documents. The digital printing press is capable of printing a print run comprising a plurality of documents which may differ from document to document within the same print run.

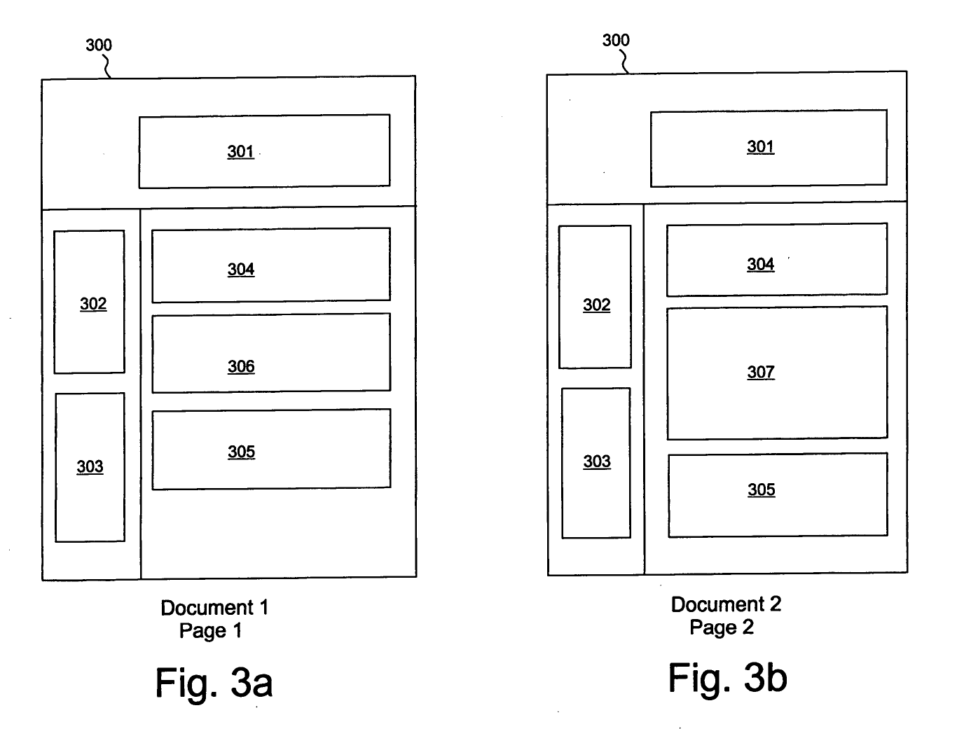

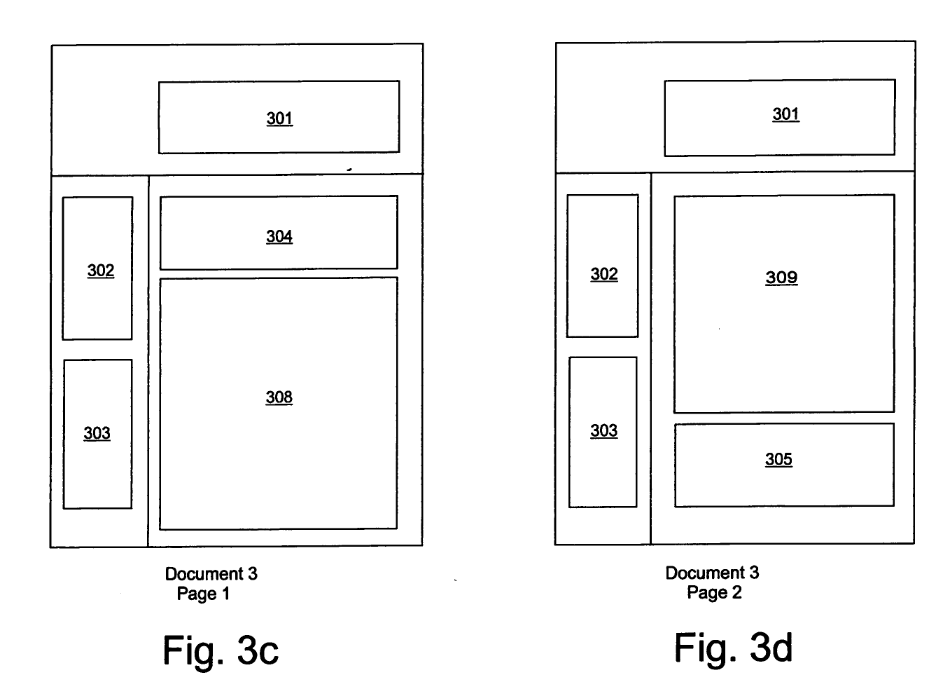

Referring to FIG. 3 herein, there is illustrated schematically a print run comprising a set of documents. A print run comprises a document set. A document set comprises a plurality of individual documents. Each document may have one or more pages. A first document is constructed according to an electronic document template 300 which defines individual blocks for areas of static content, 301-305, as well as one or more blocks 306 assigned for variable content, being content which varies from print item to print item.

Referring to FIG. 3b herein, there is illustrated a second document constructed according to the same document template as shown in FIG. 3a, comprising a plurality of static content blocks 301-305, and a variable content block 307, wherein the amount of space required for the variable content is larger than that for the equivalent variable content in FIG. 3a.

Referring to FIG. 3c herein, there is shown a front page of a third document, according to the document template, having static blocks 301-304, and in which content in a variable block 308 displaces static content in a static content block 305.

Referring to FIG. 3d herein, there is illustrated schematically a second page of the same third document, where variable content block 309 is a continuation of variable content block 308, and which causes the third document to extend to a second page.

In the above examples, for different print items, the size of the variable blocks can be adjusted as between different print items in the same print run.

The documents shown in FIG. 3 may be specified as an XSL-FO flow by the graphic artist. The XSL-FO flow is input into a rendering engine, which outputs a PPML flow which identifies re-useable objects as follows.

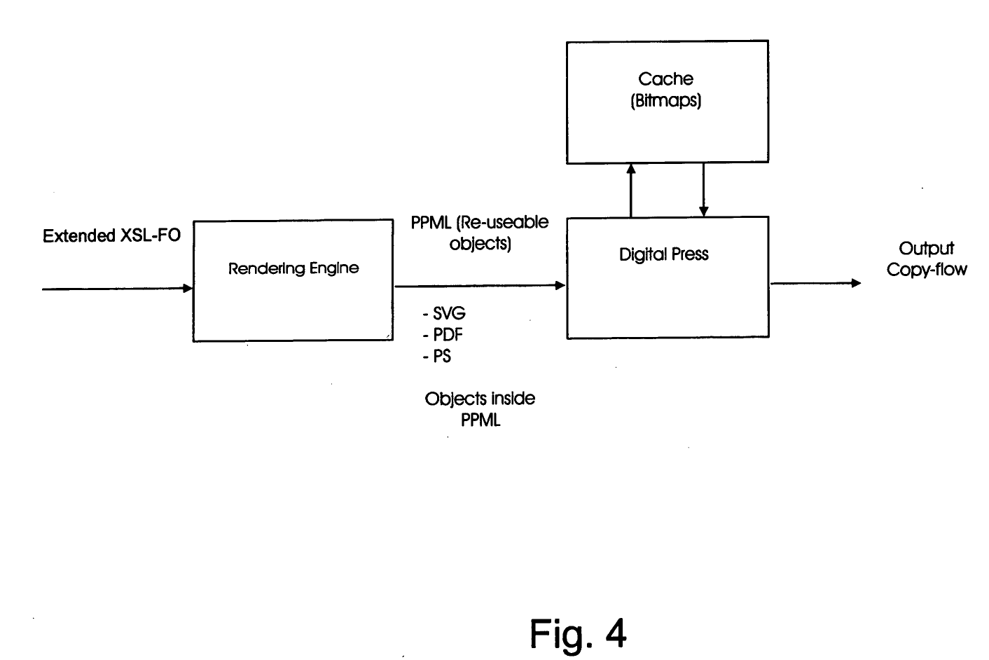

Referring to FIG. 4 herein, there is illustrated schematically an XSL-FO rendering engine for converting an XSL-FO copy flow into a PPML flow including an object output, such as SVG, PDF or PS. When the document is rendered, the digital printing press can take advantage of the fact that as between different print items in the same print run, some of the static content is identical between print items, and some of the blocks maintain the same position within a print item.

Within PPML, there is a concept of a re-useable object. Therefore, if a re-useable object is defined in a PPML document, the digital printing press can take the re-useable PPML object, and rasterize it, to produce a bitmap, which can be stored in a cache. Once an item of content has been rasterized and stored as a bitmap, there is no need to re-render that same item of content for a successive print item in a print run. The digital printing press takes the stored bitmap, and places it in a position specified in the document for that particular print item. The stored bitmap can be re-used in successive print items of the same print run.

This may give a large performance advantage for a digital printing press, and for an FO rendering engine because there is no need to keep re-rendering the same item of static content for each different print item in a print run, and at the press the rasterizing stage, which is computationally expensive, need not be repeated for static content items which recur.

Considering the stream of documents, for example as shown in FIG. 3 being input into a rendering engine, the rendering engine can be configured to produce a PPML output in which there is a re-useable object, for example an SVG, PDF, or PS object which is rendered, but not yet rasterized. The re-useable object is contained within the PPML. The advantage for the rendering engine producing PPML, is that it can produce a re-useable object.

As a further enhancement inside the FO rendering engine, incremental changes can be made to successive documents. A first document can be rendered, with individual static content items being stored as rendered objects in the form of areas. For a successive document, the changes to the first document can be tracked, such that for each static object, the position in a specific page of the object is recorded, and it can be determined whether the position of that object is the same in the present document, as in the previous document. The fact that the static objects' position is recorded in a specific page determines how the object is laid out.

An XSL-FO flow entering the rendering engine comprises a plurality of blocks of content, where each block comprises static content which may be re-useable between different blocks, and variable content which differs from block to block. The static content is repeated in every block, even though it may be the same as in a previous block. An output flow of the rendering engine comprises a PPML copy-flow comprising reuseable content items, and a set of page descriptions specifying the layout of content within pages for one or more documents, including sizing, and positioning on the page of static content items, and sizing and positioning of variable content items.

The PPML copy-flow is received by a digital printing press which converts the re-useable static content items to bitmaps which are stored in a cache. The digital printing press rasterizes each document in the PPML flow, inserting the bitmap at the appropriate place specified in the PPML document.

For a specific example, in the second document of FIG. 3b herein, the static blocks 301-305 are the same as in the first document illustrated in FIG. 3a herein. The only difference is that the variable content block 307 in the second document is different to the variable content block 306 of the first document.

Therefore the static content items in each of the static content blocks 300-305 can be converted into a separate corresponding respective object and stored as a set of areas, as the first document arrives at the rendering engine.

The first and second documents are effectively different instances of the same document template, with variations in content. A first instance of the document is sent, which has static and dynamic content. Then, a second instance of the document is sent which also has static and dynamic content. The static content in the second instance of the document is the same as the static content in the first instance of the document, but the dynamic content in the second instance of the document is different to the dynamic content in the first instance of the document.

A rendering operation, which lays out the static and variable content, and especially the variable content, needs to be done on order to determine where the static content will be positioned. In XSL-FO, there is a concept of a flow where objects follow each other, but they do not have a fixed position on a page. The blocks do not have a specified position such as an X, Y position or a width and height, but they have associated layout information such as font and styling information. The XSL-FO flow is a sequence of content which does not specify its position within a document but which has rich styling information, so that there is a precise description of how to style text, tables, or other content items.

It is the function of the rendering engine to determine in which page the content will be positioned and during the rendering operation, the rendering engine determines which page individual content items will appear on, where page breaks will occur, and where breaks in content will occur between one page and another. Therefore, it is the rendering engine which determines the final layout of the content items within a document and the layout of static and variable content items on pages of a document.

The rendering engine starts from the beginning of one of the pages as being a site to render the content into. The rendering engine then starts to determine where the content will be placed and determines text wrapping, and spacing of content within a page and general layout of the content within the pages.

When the rendering operation has finished this process for a first block of XSL-FO flow, it selects a next, second block of XSL-FO flow and repeats the process for that second block. Similarly, for third and successive blocks of XSL-FO flow.

At the digital printing press, for the second document and for successive documents, both the areas, and their positioning on a page can be re-used without the need to rerender those items of static content. Therefore, the second document need not be supplied to the digital printing press as a full content, but can be supplied to in the form of a document description which specifies re-useable objects which have already been used in an earlier document, plus any variable content or incremental changes from a previous document. Similarly, successive documents in a copy flow, can refer back to content objects which first occurred in an earlier document.

Consequently, a stream of copy sent to the digital press may consist of:
a document template specifying a layout of a plurality of copy windows;
individual static content items which can be re-used between successive documents;
information about a positioning and sizing one or more variable copy-holes for containing variable content;
information about whether the variable content copy-hole overrides or displaces a static copy-hole;
variable content, which may differ as between different documents in a copy flow.

Once the first document in a copy flow has been received by a digital printing press, in order to produce the second document, all that needs to be supplied to the digital press is information concerning the differences between the second document and the first document. This includes information concerning the differences between the position of the first variable content copy-hole in the first document, and the second variable content copy-hole in the second document, and the variable content of the second document. Additionally, information concerning positioning of the static content is provided. Therefore, the PPML flow comprises static content items (at the beginning of the flow), data describing the positioning of the static content items for each document in the flow, dynamic content items, and data describing the positioning of the dynamic content items for each document in the flow. The data describing positioning of the static content is provided for each document in the flow, even if the position of a reused static content item is the same in that document as in a preceding document. Each of the static objects are specified only once in the flow, and each of the variable objects are specified only once in the flow. The positions of both the static content items (which may be reusable) and the variable content items are specified for each instance of a document in a copy flow.

The first time a PPML document which has content rendered by the rendering engine, is presented to the digital press, those static content objects can be presented as being re-useable objects. The second time a document in a flow is rendered there can be just expressed a reference to the re-useable objects, together with information describing the difference between the variable copy-hole of the second document and that the first document. The variable content of the second document is also supplied to the digital press.

Referring to FIG. 3c, when the third document is presented to the digital press, the digital printing press only needs to rasterize the third copy-hole 308, and similarly, when the fourth document is presented, the only content that needs to be re-rasterized is the fourth variable content in the fourth variable content copy-hole 309.

This can speed up the processing of a PPML document significantly. The first document, corresponding to the first page in the PPML flow, may take longer to rasterize, since all of the static content objects are being rasterized. However, second and subsequent documents in the PPML flow will be printed more quickly, since there is less rendering of content to be done, and rendered objects from the first document are re-used.

The modified rendering engine performs two functions at the same time. Firstly, the function of laying out the content and determining how the blocks and the text content will flow. The rendering engine has the responsibility of understanding how the text will flow, and how the blocks will flow in the final output.

The output of the rendering engine could be either a rasterized format, or a pre-rasterized format. PDF of post script, or SVG are each pre-rasterized formats. Some types of rendering engine may produce a JPEG or a GIFF output, which are rasterized outputs.

Where the rendering is already done by the rendering engine, the rasterizing is done by the PPML consumer.

The modified rendering engine has visibility of all the different instances of the documents and can determine whether a content object is re-useable or is disposable, and whether it has an appropriate level of granularity of content objects to make sure that the PPML output of the rendering engine represents all of the information input in the original XSL-FO flow.

An extension command to XSL-FO for identifying re-useable static content may take the following form:
<fo:block content=“STATIC” . . . ID=“ ”>
<fo:block>

The example XSL-FO command distinguishes between a static object and a dynamic variable object. The rendering engine treats all objects presented in the above form as objects to be rendered, without doing any further checking.

Known XSL-FO is extended in the specific embodiments herein, by the attribute:
Content=“STATIC” . . . ID=“ ”
   to signify to the rendering engine whether the content is static or dynamic.

The extension for identifying the static or variable content is an efficient way of identifying content at the rendering engine, without the rendering engine having to compare rendered objects with each other to determine which objects are static, and which are variable.

At the rendering engine, the first time that a content having a particular identification is rendered, it is stored as a bitmap. Subsequently, the content can be referred to by the unique identification ID of the bitmap object For subsequent documents containing the same static content object, it is not necessary to have the un-rendered content itself, since this is already stored by the rendering engine. All that needs to be provided is an identification identifying the bitmap object, and information describing the position of the object within the subsequent document.

If the content object is being positioned in the same place as in a previous document, and the sizing is the same, then the instruction in the subsequent document in the flow can be a simple instruction to re-use the object, and its positioning and size, as in a previous document of the flow.

If the position of the content object in the subsequent document in the content flow is in a different place to a previous document in the flow, then the position information is all that needs to be updated in the PPML description of the subsequent document.

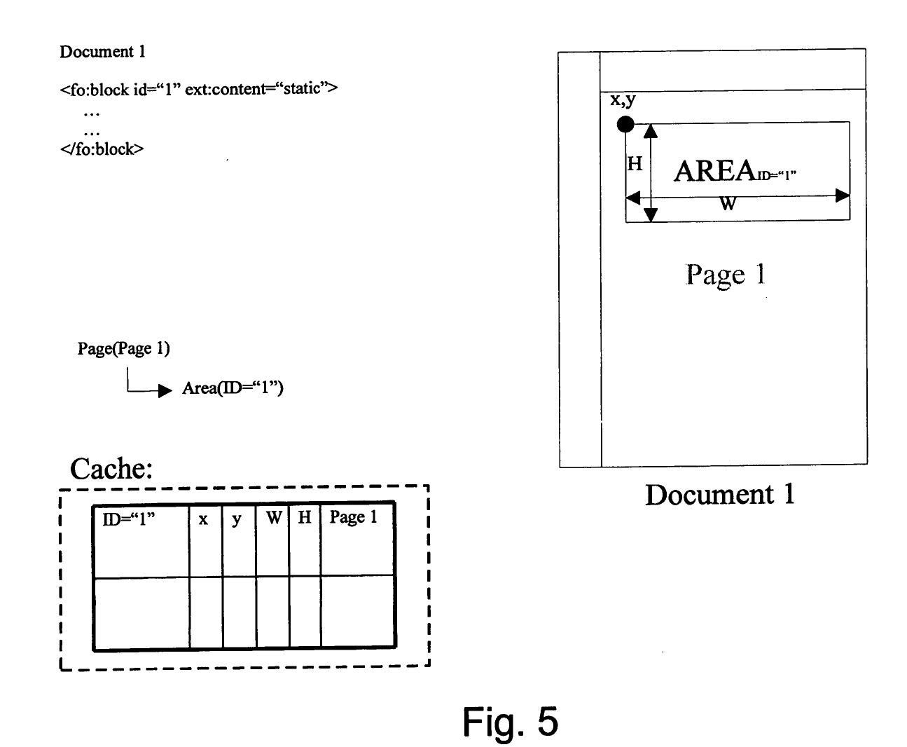

Referring to FIG. 5 herein, there is illustrated schematically process steps involved in handling a first document, carried out at a modified rendering engine according to a specific embodiment of the present invention.

An XSL-FO command within a block (corresponding to the first document), describes an identification of a content object ID=“1”, and a type of the content, in this case a static content object. The command, written in XSL-FO is of the form:
<fo:block ID=“1” ext: content=“static”>
<fo:block

The rendering engine stores an object with identification ID=“1” which is positioned within a PPML page at co-ordinates X, Y, and having width W and height H as shown in FIG. 5.

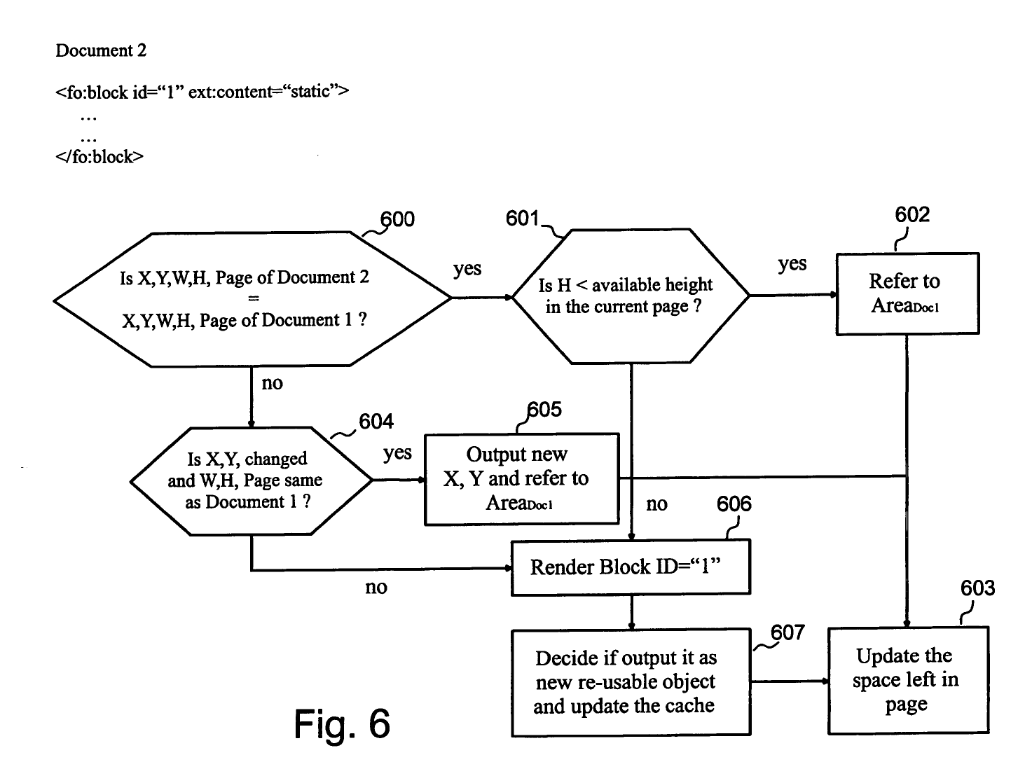

Referring to FIG. 6 herein, there is shown an XSL-FO command for a second document, corresponding to a next block in the XSL-FO flow. The content object can be specified by its identification ID=“1”. The rendering engine undergoes processes as shown in FIG. 6. In process 600, the rendering engine checks whether the X, Y co-ordinates of the object in the second document, and the width W and height H of the object are the same as for those in the first document. If so, then in process 601, the rendering engine checks whether the height H of the object is less than the available height in the current PPML page which is being created. If the height H of the object in the second document is less than the maximum available height in the current page, then in process 602, the rendering engine refers to the stored area of the object, which was stored when processing the first document 603 proceeds to update the space left in the page of the second document in the copy-flow.

If, in process 601, the height of the object is equal or greater than the available height in the current page, then the rendering engine proceeds to render the block and give it its new identification in process 607. The rendering engine then determines whether to output the block as a new re-useable object and update the cache, and in process 603 proceeds to update the space left in the page.

If in process 600, the position, width and height and page of the second document is not equal to the position, with the height in the same page of the first document, then in process 604, if the position of the object relative to the page of the document is changed in the second document, but the width, height and page number of the object in the second document are the same as those in the first document (in other words, if it is only the position of the object which has changed on the same page, but the object has the same dimensions and is on the same page in the second document as in the first), then in process 605 the rendering engine outputs a new X, Y position and generates a reference to the area of the object in the first document. In other words, the PPML output for that object in the second document corresponds to a new X, Y position and a reference to the area in the first document corresponding to the object. In process 603, the rendering engine then proceeds to update the space left on the page of the second document.

If however, in process 604, the X, Y position of the object on the page has changed, but either the dimensions (width, height) of the object have changed, or the object appears on a different page in the second document two compared to its position in the first document, then in process 606 the rendering engine renders that block with a new identification. In process 607 the rendering engine determines whether to output the object as a new re-useable object and update its cache or not. The rendering engine then proceeds to update the space left in the page in process 603 as described previously.

Where the rendering engine outputs a new re-useable object, having different dimensions to the same item of content in the first document, the content which goes through the rendering engine is the two blocks of content, which are in fact the same block of content, rendered differently for the first document and the second document, because the instruction for the second document has the content object having different dimensions compared to the dimensions of the same content as it appeared in the first document.

Every time a content item is rendered, it is stored along with a data entry describing its position and sizing within a document. For subsequent documents, the same content item can be re-used if it is the same size, and re-positioned within a document. If the content is specified to be reused, but at a different size, then it can be re-rendered at a different dimension, and re-used in a subsequent document, at the same or at a different position in the document, to that which is occupied in a previous document.

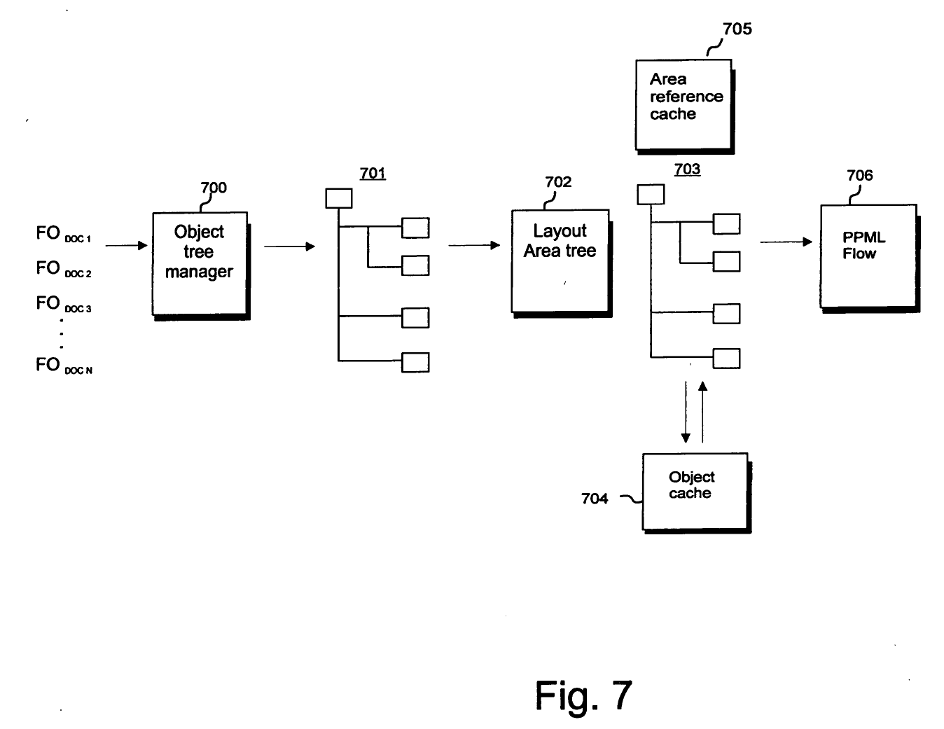

Referring to FIG. 7 herein, there is illustrated schematically internal processes, architecture and operations of the rendering engine. XSL-FO blocks are received by the rendering engine. Individual content items within each block are treated as objects by an object tree managing component 700, which arranges the objects in a tree structure 701. A layout algorithm 702 lays out the objects into different areas of a PPML page. Objects may be stored in an object cache 704. A reference of the areas is maintained in an area reference cache 705. The output of the rendering engine is a PPML flow 706.

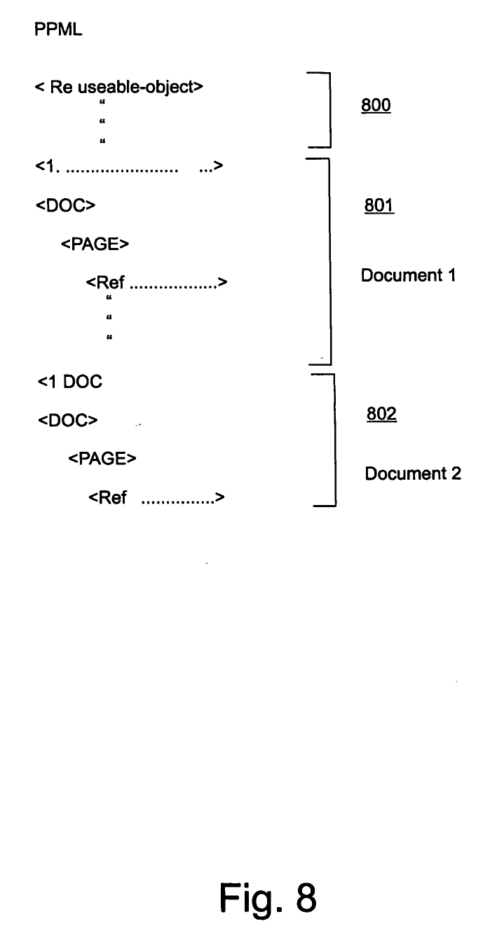

Referring to FIG. 8 herein, there is illustrated schematically one example of a PPML output of the rendering engine.

The PPML output comprises a list 800 of re-useable objects; and a description of one or more documents, where each document specifies one or more pages, and then within the pages, references to one or more objects which are not re-useable, but which are the dynamic objects which change between different pages.

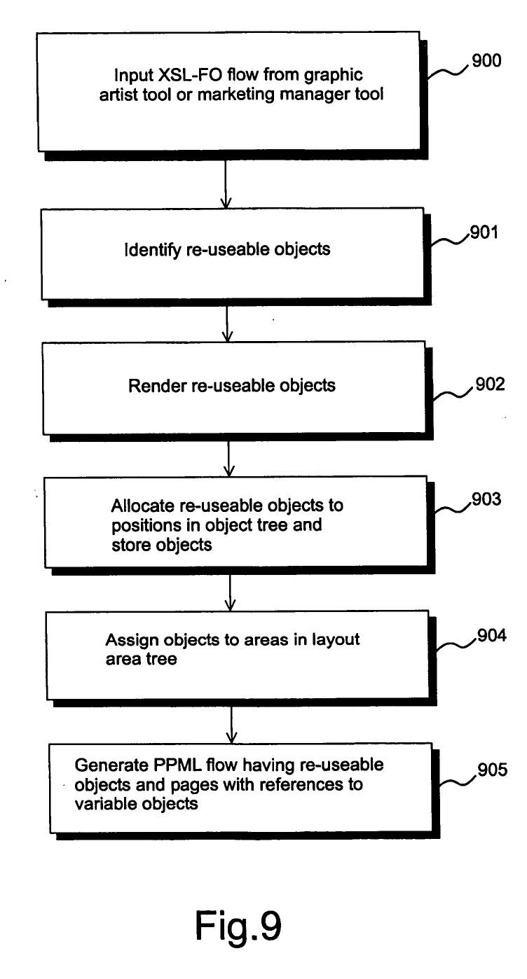

Referring to FIG. 9 herein, there is illustrated schematically process steps carried out by the rendering engine for producing a PPML flow into a pre-processed format. In process 900, an XSL-FO content flow is input from a graphic artist tool or from a marketing manager tool. In step 901, any objects which are re-useable, i.e. which are used between two or more blocks in the XSL-FO flow are identified and they are rendered in process 902. The re-useable objects are allocated to positions in an object tree and stored as objects in a local cache in process 903. In process 904, objects are assigned to areas in a layout area tree. This includes both re-useable objects, and objects which are not re-used and which may be unique to individual pages or documents within the XSL-FO flow.

In process 905, a PPML flow is generated in the form shown in FIG. 8, which has a set of re-useable objects, and a list of pages with references to variable objects, and variable content for those pages.

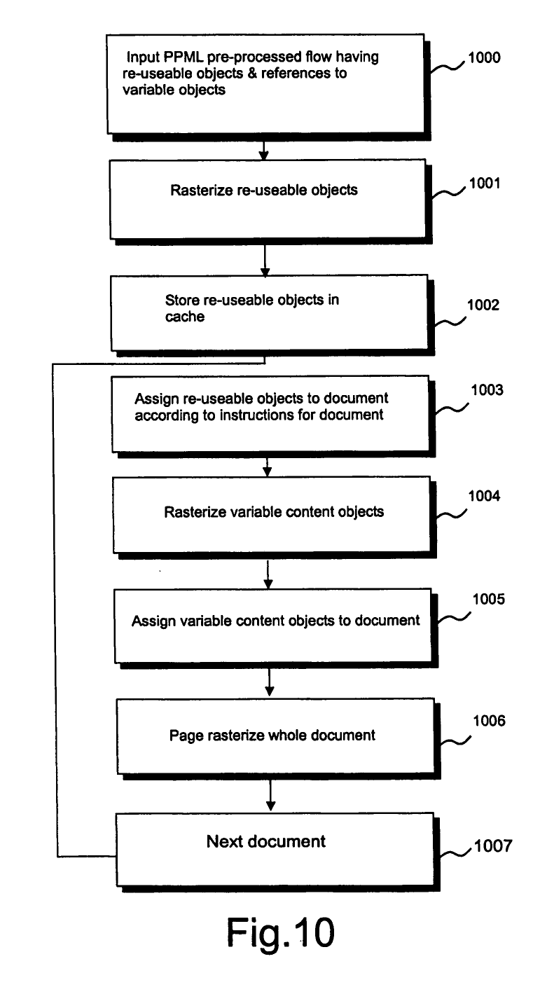

Referring to FIG. 10 herein, there is illustrated schematically processes carried out by the digital printing press for production of a copy flow comprising a plurality of documents, in response to the pre-processed PPML flow as generated in FIG. 9 herein.

In process 1000, the pre-processed PPML flow is input into the digital press. The PPML flow comprises a set of re-useable objects, and references to variable objects as specified for each document, if different from the re-useable objects. Final output of the pre-processing stage comprises all of the re-useable objects, which may be contained in a single PPML document, and which are in rasterized form, and a list of positions at which the re-useable objects occur within the document pages and each of the disposable content items, i.e. the variable content items which are re-used but are only used once in the PPML flow. In process 1001 the re-useable objects are identified and rasterized. In process 1002, the digital press stores the re-useable objects in a local cache, if not already stored from a previous operation. In process 1003, the re-useable objects are assigned to their respective positions within a document according to the instructions for that document. In process 1004, variable content objects for a particular document, as specified in the PPML flow are rasterized, and in process 1005 the variable content objects which are specific to a particular document are assigned to that document. In process 1006 the whole document is rasterized. The next document is selected in process 1007, and processes 1002-1005 are repeated for the next document in the PPML flow.

The process described in FIG. 10 may be carried out as a second stage process by a digital printing press different to the rendering engine used for the first process of FIG. 9, or by the digital press having the same rendering engine which originally created the pre-processed PPML flow. In the case where the second stage process of FIG. 10 is carried out by a different digital press, that press will not have already pre-stored the re-useable objects, and so cannot reference objects already stored, since it would be the first time that the rendering engine of the new press has had access to those re-useable objects, from the PPML pre-processed flow. Therefore, the PPML input needs to have the static and dynamic objects in area or block form as well as the references for re-use, in order for the PPML consumer to be able to rasterize the PPML documents.

However, where the rendering engine is the same rendering engine as that used to produce the PPML pre-processed flow, then the rendering engine may still store some of the rendered objects locally, in which case, it need not store them again in its local cache, but can refer to the earlier stored re-useable objects.

There will now be described a further example of processing of a document by a modified rendering engine and digital printing press according to a specific embodiment and method of the present invention.

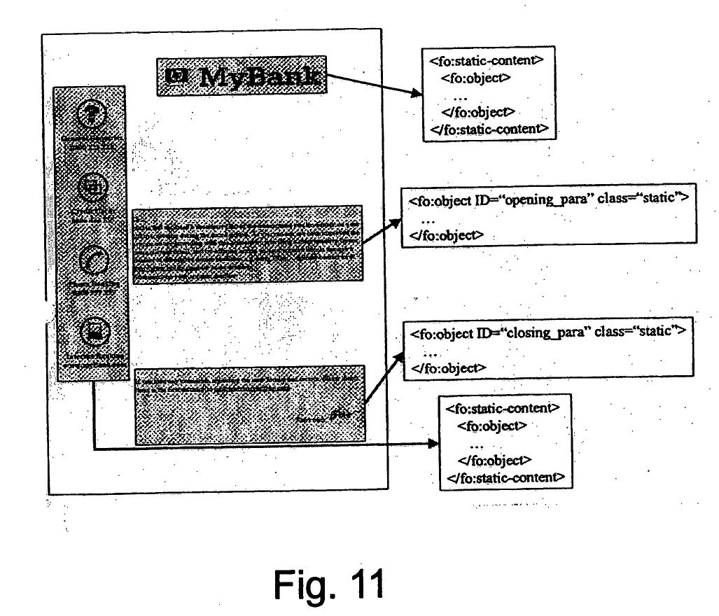

Referring to FIG. 11 herein, there is illustrated schematically an example of a layout of a finished rasterized transactional document, such as a bank or credit card statement which is made up of one or more static content objects and one or more dynamic content objects which are supplied in XSL-FO, and which vary from document to document for each customer. There is shown a document model, (also called a document template) in which static objects 1100-1103 are laid out in copy-holes, interspersed with regions for insertion of variable content. Each object fo: object is identified using an identifier and additionally, the XSL-FO notation has been extended using a class attribute to identify if the object is static or dynamic. This type of extension is back compatible, since the XML specification allows the use of the class attribute regardless of the specific name space used.

Other components of the document will be fulfilled using a customer specific data which varies from customer to customer. The data in the variable content determines the number of pages in the document.

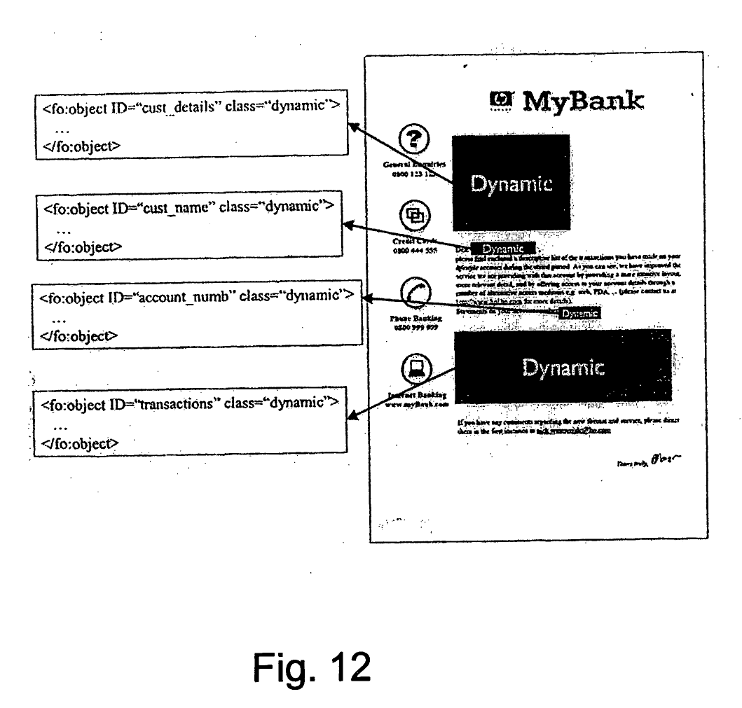

Referring to FIG. 12 herein, there is illustrated schematically dynamic content components of the finished document of FIG. 11. As for the static part, the fo: objects have their own identifier, and the class attribute, to express their variability. The XSL-FO rendering engine can create PPML re-useable objects for all of the fo: objects available inside the static content regions. In the example shown, the four static content regions are reused every time a page is created inside a page sequence master. The rendering engine can store all the static content as re-useable objects, which can be re-printed for successive pages.

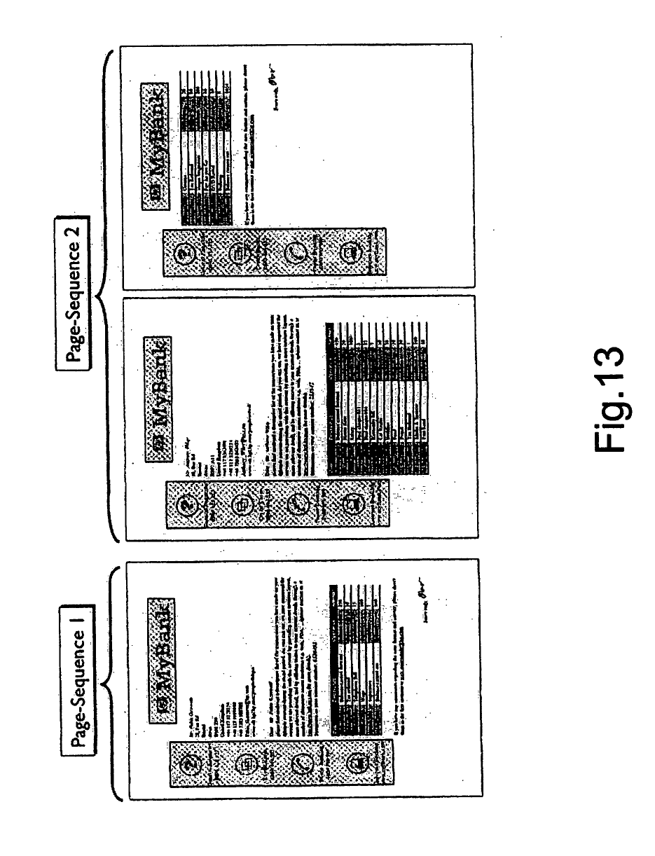

Referring to FIG. 13 herein, there is illustrated schematically first and second page sequences within a print run, illustrating how re-use of static objects is applied to static regions within the document across multiple page sequences inside a document set. The static content areas are rasterized once in the digital printing press and then referenced for each successive page in the document as well as for every document in the document set. In the case of a print run comprising transactional documents, the number of pages in a document set can be hundreds or thousands of pages, and similarly, the number of documents in a document set can be hundreds or thousands of pages.

The incremental rendering approach extends re-usability of content to the body of the documents where they are situated in a flow. Using the ID and class attributes, the XSL-FO rendering engine can keep track of static content objects which have already been rendered by the rendering engine, and create a look up table where the identification ID's can be stored for further reference, both inside the same page sequence, or across different page sequences.

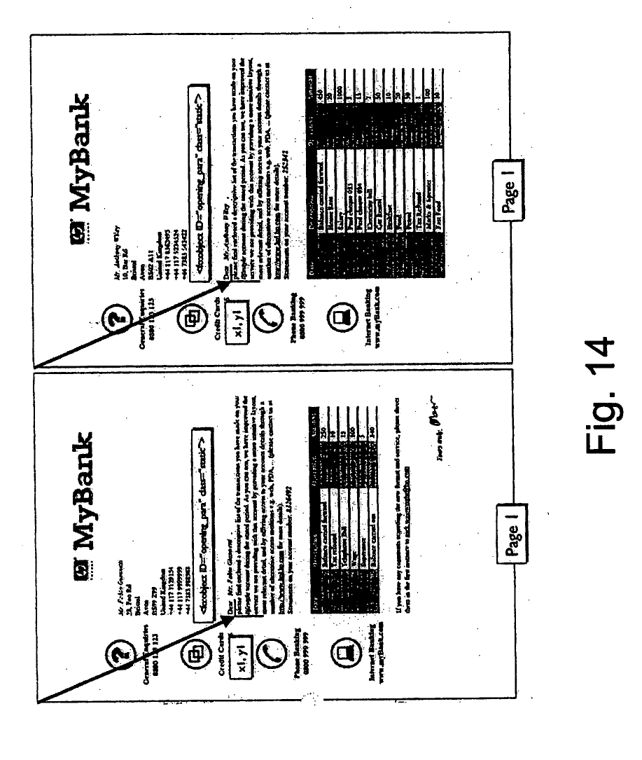

Referring to FIG. 14 herein, there is illustrated schematically a first page of a document, showing how an object can either be rendered and printed in exactly the same position in all pages, or an object can be shifted or rearranged in a different position on a page using the MARK element in the PPML, without effecting the re-usability of the objects.

In this case, in the first pages of two documents, there is a static object as shown arrowed:
ID=“Opening para”
   which has been rendered in a same position X₁, Y₁ in each of the two documents, and which is output as a re-useable object. The PPML marks (copy-holes) in the two document pages refer to the static object and position it in the same spot in each of the two documents.

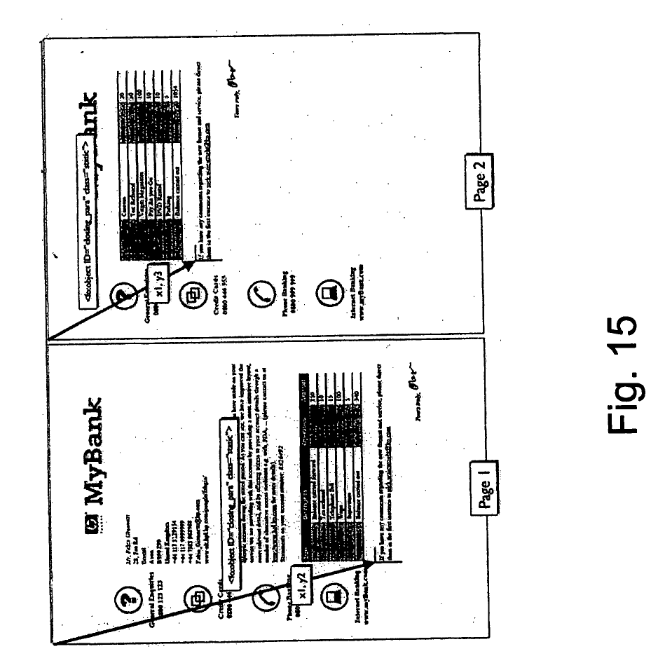

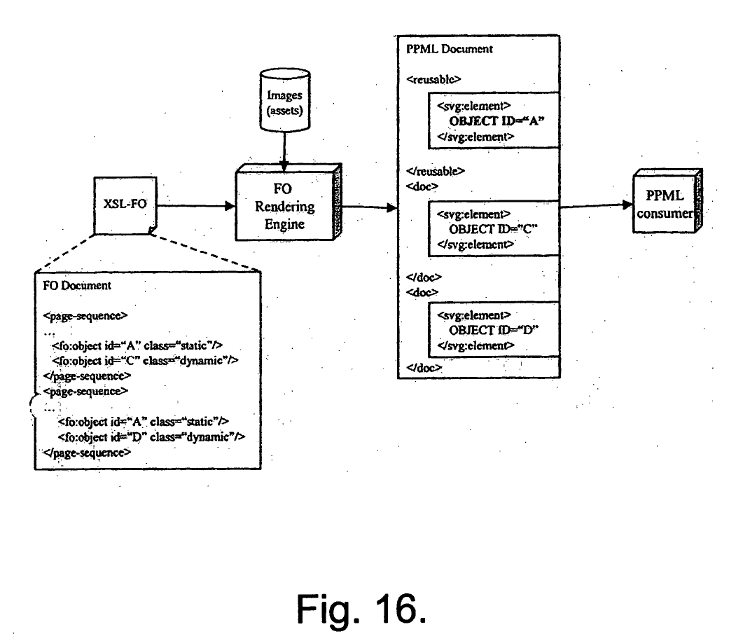

Referring to FIG. 15 herein, in the second case, the static object with the identification:
ID=“Closing para”
   is in different pages. It has the same rendering, but it is placed in a different position and on a different page. In the first document, it is placed on page 1 at position X₁, Y₂ and in the second document it is placed on page 2 at position X₁, Y₃.

When the same static object has been rendered in pages with different margins, the object can be saved as a different object, and added to a look up table in the rendering engine, to find out if there are any possible re-uses of that object, and to save the object as a re-useable object. A static object may be truncated between pages. The possibility of the truncation happening always at the same place between successive documents is relatively low.

Referring to FIG. 16 herein, there is illustrated schematically a rendering process for rendering from an XSL-FO flow into PPML flow containing rendered objects. In this example, SVG is used for the rendered objects, but in alternative methods, other languages such as PDF, PS, or any other page description language may be used.

A further advantage of the specific embodiments disclosed herein is that to condense the re-useable content in re-useable objects avoids content replication. This may reduce the amount of information and assets required to be transferred to the digital printing press when the rendering process is completed. If the number of documents is high, this may result in a dramatic file size reduction.

Specific embodiments disclosed herein may also enable content driven and transactional documents to be published on a digital printing press. A major aspect of digital printing presses is the possibility of personalisation documents for each individual recipient of the document, or for classes of individual document recipients. In a customised document, it is important to ensure that the static content, which could also include bounded sets of pre-generated content such as used in themes, to be reused is rasterized only once. Since the rasterizing process is time consuming and computationally expensive, it can affect the overall printing press performance significantly.

Further more, the adoption of the solution based upon XSL-FO augments the reuse scope from a document set to a page sequence set, which usually contains more than a document set. Potentially, if page sequences are derived from the same page sequence master, or share some page definitions, they can span an entire job or job collection.

The embodiments described herein provide an optimisation technique which can take full advantage of the re-usability available in known languages such as PPML. Using XSL-FO as a composition language for the documents, static layout documents can be supported as well as content driven layout and transactional documents. The XSL-FO rendering engine is responsible for the document rendering in a page description language. In the example shown, the target page description language is PPML.

In XSL-FO, there is a concept of blocks. The input document is in XSL-FO, and the output document is in PPML. The re-usability is expressed at block level in XSL-FO. These blocks are mapped into PPML re-useable objects. In PPML, re-useable objects are stored as bitmaps.

In XSL-FO, the concept of re-usability induces re-use of the same content which has been laid out in the same page (and which may also be laid out in the same position on the same page). Consequently, the re-useable object may have the same width and height in the same page, and looks the same where it is re-used from page to page. It can therefore be saved as a re-useable object in PPML.

Further, PPML has a concept of re-useable objects with differing scope. The scoping spans from intra-documents to objects inside the same document page. A specialised XSL-FO rendering engine may potentially take full advantage of the PPML re-usability feature, generating as output an optimised PPML flow. The optimisation works well, especially in cases where there are some personalised elements in a pre-defined template. Such cases are common practice in variable data printing work flows.

The embodiments of the XSL-FO rendering engine disclosed herein can optimise an output produced in a way that performs an incremental rendering. It is possible to render a first document in a document sequence, and use it as a master. Subsequent documents, can be expressed as variations from the master document, by just re-positioning objects which are identified as being re-useable.

XSL-FO provide some regions as static content regions. Furthermore, by adding a basic extension to the known XSL-FO notation, it is possible to identify static and dynamic objects generated inside the copy flow, and to allow the rendering engine to explore this information to identify which objects are re-useable.

In the specific embodiments herein, in one aspect, during the rendering phase, rendered re-useable static objects are created, and rendered disposable variable objects are created.

In another aspect of the embodiments, there is introduced the concept of incremental rendering of an XSL-FO flow, in which once a first instance of a document has been rendered, because the next (second) instance of the document has commonality with the first instance, when the second instance of the document is rendered, each time an item of content is found which has been already rendered in a previous instance of a document, and provided the previous instance of the document meets all the criteria for re-use in the succeeding instance of the document, then this will be rendered in the same way as the previous document, therefore there is no need to re-render that material, but the previously rendered first instance of the document can be re-used, and all that needs to be specified in the second instance of the document is the position of the re-used content items.

1. A method for producing a copy flow from an XSL-FO input, said method comprising:
receiving an XSL-FO document which identifies at least one document sequence, wherein said document sequence identifies at least one static content item, and at least one dynamic content item;
rendering said at least one static content item, and storing said rendered at least one static content item;
rendering said at least one dynamic content item; and
generating a PPML document which comprises a set of re-useable rendered content items and position information for positioning said rendered content items.

2. The method as claimed in claim 1, wherein during said process of rendering, each said static content item is rendered only once.

3. The method as claimed in claim 1, wherein during said process of rendering, each said dynamic content item is rendered only once.

4. The method as claimed in claim 1, wherein said position information comprises information describing, for each instance of use of a said static content item, data describing a positioning of that static content item.

5. The method as claimed in claim 1, wherein said positioning information comprises, for each rendered dynamic content item, position information describing a positioning of said rendered dynamic content item.

6. The method as claimed in claim 1, further comprising:
rasterizing said PPML document to generate a rasterized copy flow.

7. Means for producing a rendered copy flow from an XSL-FO input, said means comprising a rendering engine capable of:
receiving an XSL-FO document which identifies at least one document sequence, and at least one static content item, and at least one dynamic content item;
rendering said at least one static content item, and storing said rendered at least one static content item;
rendering said at least one dynamic content item; and
generating a PPML document which comprises a set of rendered re-useable content items and which contains position information for positioning said rendered content items.

8. The means as claimed in claim 7, further comprising:
a PPML consumer capable of receiving said PPML document and generating a rasterized copy flow from said PPML document.

9. A digital printing system comprising:
means for identifying a set of re-useable objects;
means for rendering said identified re-useable objects; means for storing said identified rendered re-useable objects; and
means for storing an identification data, identifying a position within at least one document of said re-useable objects.

10. A method of generating a copy flow comprising:
identifying a set of re-useable objects;
rendering said identified re-useable objects;
storing said identified rendered re-useable objects; and
storing an identification data, identifying a position within at least one document of said re-useable objects.

11. A personal printing mark up language (PPML) document comprising:
a set of reuseable objects; and
a set of document descriptions, each said document description identifying at least one said re-useable object.

12. The PPML document as claimed in claim 11, further comprising at least one variable content item, which varies as between different pages within said PPML document.

13. The PPML document as claimed in claim 11, further comprising, for each document description, data identifying a position of a said re-useable object.

14. The PPML document as claimed in claim 11, further comprising:
at least one variable content item; and
data identifying a position of said variable data content item within a said page description.

15. A PPML flow comprising:
a plurality of rendered content items;
a plurality of document descriptions for describing a plurality of documents comprising said PPML flow, each said document description comprising a field for identifying at least one said rendered content item; and
identifying a position of said at least one rendered content item within said document.

16. The PPML document as claimed in claim 15, wherein a said rendered content item is specified within said plurality of document descriptions to be re used at least once.

17. The PPML document as claimed in claim 15, wherein a said content item is specified to be re used within at least two documents of said flow, at a same position within said two documents.

18. A method for generating a copy flow document comprising:
receiving a plurality of rendered re-useable content items;
receiving a plurality of page descriptions, each said page description comprising a field for identifying at least one said re-useable said content item;
identifying a position of said at least one re-useable content item within a document;
identifying a variable content item; and
identifying a position of said variable content item within a document.

19. A method of processing a copy flow, comprising:
receiving a document description language copy flow, including an embedded content;
identifying re-useable content items in said input copy flow;
rendering said re-useable content items;
storing said re-useable content items as objects; and
generating a page description language copy flow comprising said rendered re-useable objects, and references to positions of said rendered re-useable objects within individual pages of said copy flow.

20. The method as claimed in claim 19, wherein said page description language comprises personal printing mark up language (PPML).

21. The method as claimed in claim 19, wherein said document description language comprises extensible style sheet language formatting objects (XSL-FO).

22. The method as claimed in claim 19, wherein said copy-flow comprises:
a set of static objects, wherein each static object is specified only once;
a set of variable objects, wherein each variable object is specified only once;
for each instance of use of a said static object, data describing a positioning of said static content item; and
for each said variable object, data describing a positioning of said variable object.

23. A method of processing a page description language content flow having a set of pre-rendered re-useable content items, said method comprising:
identifying said re-useable pre-rendered content items in said page description language flow;
reading instructions for placement of said re-useable rendered content items;
assigning said rendered re-useable content items to positions within an output document according to said instructions;
identifying pre-rendered variable content items in said input copy flow;
identifying instructions for placement of said rendered variable content items in said input copy flow;
placing said rendered variable content items in an output document according to said variable content item placement instructions; and
rasterizing said output document.

24. A method of producing a copy-flow from an XSL-FO input, said method comprising:
rendering a set of static content items, which after rendering are stored as objects and treated as being reusable; and
rendering a set of variable content items, which after rendering, are treated as disposable objects which can be overwritten after a single use.

25. The method as claimed in claim 24, further comprising:
for each said re-useable static content item, specifying a position of said static content item; and
for each use of a said variable content item, specifying a position of said variable content item.

26. A method of producing a copy-flow from an XSL-FO input, said method comprising:
rendering a first instance of a document;
rendering a second instance of a document;
identifying at least one object of the second instance of the document, which is already rendered in the first instance of the document; and
re-using said already rendered at least one objects of said first document instance by placing said rendered object in a position in said second document instance.
